(19) United States
(12) Patent Application Publication
(10) Pub. No.: US 2022/0343658 A1
(43) Pub. Date: Oct. 27, 2022

(54) Audio and Video System for Capturing Surroundings of a Vehicle

(71) Applicant: David Alexander Nolasco, Hercules, CA (US)

(72) Inventor: David Alexander Nolasco, Hercules, CA (US)

(21) Appl. No.: 17/730,253

(22) Filed: Apr. 27, 2022

Related U.S. Application Data
(60) Provisional application No. 63/180,188, filed on Apr. 27, 2021.

(51) Int. Cl. G06V 20/58; G07C 5/08

(52) U.S. Cl. CPC G06V 20/582; G07C 5/0833

(57) ABSTRACT

The present invention relates to vehicle systems to selectively record audio and video around a vehicle using a plurality of cameras and microphones dispersed on the exterior of the vehicle. The cameras and microphones are selectively activated using a pair of paddles installed on either side of the steering wheel. Audio and video obtained by the cameras and microphones are displayed through an electronic dashboard and can be stored in an internal memory. In one embodiment, the system detects emergency situations and automatically contacts one or more emergency services. The electronic dashboard is configured to connect to an electronic device for transmitting recorded audio and video. The invention can be integrated into a vehicle during manufacturing of the vehicle or added to a vehicle as an aftermarket system. The invention can also be used by law enforcement to detect emergencies and illegal activity.

### CROSS-REFERENCE TO RELATED APPLICATION

The present application claims priority to, and the benefit of, U.S. Provisional Application No. 63/180,188, which was filed on Apr. 27, 2021, and is incorporated herein by reference in its entirety.

### FIELD OF THE INVENTION

The present invention relates generally to audio and video systems. More specifically, the present invention relates to a novel system integrated into vehicles for capturing images, video, and audio of the outside area around a vehicle. The system monitors and records images, video, and audio obtained from a plurality of cameras and microphones installed on the exterior of a vehicle. An electronic dashboard, receives, outputs, and stores the images, video, and audio. The system can be activated using a pair of paddles installed on either side of a vehicle's steering column. The system can also identify emergency situations and contact emergency services. Accordingly, this disclosure makes specific reference thereto the present invention. Nonetheless, it is to be appreciated that aspects of the present invention are also equally applicable to other like applications, devices, and methods of manufacture.

### BACKGROUND

Vehicle accidents commonly cause destruction of property and personal injury. The dispatch of emergency services is dependent upon individuals or highway systems reporting the emergency. Delays in contacting emergency services can lead to additional loss of property, more serious injuries, and increased fatalities. Vehicle accidents are often caused by reckless drivers or are part of insurance fraud; therefore, the reckless drivers and fraudsters may flee the scene of an accident to avoid arrest. Though many highway systems have video recording systems, these systems are not found everywhere and are often inadequate with respect to the ability to properly identify vehicles and people involved in vehicle accidents and emergencies.

Therefore, there is a long-felt need in the art for improved systems and methods for monitoring, detecting, and reporting vehicle emergencies. There is a need for vehicle safety monitoring as well as automatic emergency detection and reporting systems that do not depend on municipal roadway cameras systems. There is a need for vehicular systems that effectively monitor and capture the audio, images, and video of a vehicle's surroundings, detect vehicle emergencies, notify emergency services, aid in the determination of the cause of vehicle accidents, and assist in the arrest and conviction of those who drive recklessly or commit vehicle-related insurance fraud.

The subject matter disclosed and claimed herein, is comprised of vehicle safety and emergency detection systems for vehicles. The systems capture images, audio, and video of the outside perimeter of a vehicle and can be used to detect emergencies, contact emergency services, and aid law enforcement in the identification and prosecution of law breakers. The systems comprise a plurality of high definition and night vision cameras mounted on the exterior of a vehicle for capturing images and video around a vehicle, a plurality of multidirectional microphones mounted on the exterior of a vehicle for capturing audio around a vehicle, a pair of hand operated paddles installed on either side of steering wheel of the vehicle, the paddles configured to activate the cameras and the microphones; wherein, the left paddle activates the cameras for capturing still images and the microphones for capturing audio, the right paddle activates the cameras and microphones for capturing audio videos. The systems also include an electronic dashboard having a display for displaying the captured images and audio video, and a scanner and zoom feature incorporated into the video system, enabling the video system to locate and zoom in on and display license plates of nearby vehicles. All recorded images, video, and audio recorders are stored internally and can be transmitted to emergency responders and law enforcement. The systems may also be used for non-emergent situations as well.

In this manner, the vehicle safety and emergency detection systems of the present invention accomplish all of the foregoing objectives and provide users with integrated systems to capture, record, and report events surrounding a vehicle.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle safety system. The vehicle safety system is comprised of a plurality of high definition and night vision cameras mounted on the exterior of a vehicle for capturing video and images around a vehicle, a plurality of multidirectional microphones mounted on the exterior of the vehicle for capturing sound and audio around the vehicle, and a pair of hand operated paddles installed on either side of the steering wheel column of the vehicle. The paddles are configured to activate the cameras and the microphones; wherein, the left paddle activates the cameras for capturing still images and the microphone for capturing audio, the right paddle activates the cameras for capturing audio videos. The system further comprises an electronic dashboard having a display for displaying the captured images, videos along with audio, and the electronic dashboard also having a scanner for locating and scanning license plates of nearby vehicles and a zoom feature to better identify vehicles, people, road signs, and other things surrounding the vehicle.

In another embodiment of the present invention, a vehicle emergency detection system is disclosed. The system includes all the elements of the vehicle safety system: a plurality of high definition and night vision cameras mounted on the exterior of a vehicle for capturing video and images around the vehicle, a plurality of multidirectional microphones mounted on exterior of the vehicle for capturing sound and audio around the vehicle, an electronic dashboard for receiving the captured videos and audios, and a pair of paddles for activating the cameras and microphones. In addition, the vehicle emergency detection system is configured to detect an emergency when one or more microphones capture the sound of an emergency vehicle's siren, one or more cameras capture a rolled or damaged vehicle, or if the system receives input from a user through the electronic dashboard. The system can be configured to automatically contact emergency services upon detecting a vehicle emergency. The system may be integrated into the vehicle during manufacturing of the vehicle or be installed as an aftermarket system.

Further modifications of the vehicle safety system and the vehicle emergency detection system may include video and audio recording, a park feature wherein the system automatically monitors the area around the vehicle when the vehicle is parked, and pairing of the system with other electronic devices, to allow users to view and hear the video and audio of the vehicle's surroundings from remote locations.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top view of a vehicle equipped with one potential embodiment of the vehicle safety system of the present invention for personal and commercial vehicles in accordance with the disclosed architecture;

FIG. 2 illustrates a top view of a vehicle equipped with one potential embodiment of the vehicle safety system of the present invention for personal and commercial vehicles in accordance with the disclosed architecture;

FIG. 3 illustrates a functional block diagram showing connection of the cameras, the microphones, and the paddles of one potential embodiment of the vehicle safety system of the present invention for personal and commercial vehicles in accordance with the disclosed architecture;

FIG. 4 illustrates a functional block diagram showing the action taken by the vehicle emergency detection system for detecting vehicle emergencies based on information received from the cameras and microphones in accordance with the disclosed architecture;

FIG. 5 illustrates a functional block diagram showing components of the electronic dashboard of one potential embodiment of the vehicle safety system of the present invention for personal and commercial vehicles in accordance with the disclosed architecture;

FIG. 6 illustrates a perspective view showing one potential embodiment of the vehicle safety system of the present invention for personal and commercial vehicles displaying video from a front mounted camera of the vehicle while also displaying the image of a scanned license plate of another vehicle in accordance with the disclosed architecture in accordance with the disclosed architecture;

FIG. 7 illustrates a block diagram showing a plurality of controls displayed on the display for controlling the images and audio video played on the display device in accordance with the disclosed architecture;

FIG. 8 illustrates a flow diagram depicting the exemplary process performed by one potential embodiment of the vehicle emergency detection system to record still images and audio in accordance with the disclosed architecture; and

FIG. 9 illustrates a flow diagram depicting the exemplary process performed by one embodiment of the vehicle emergency detection system to record live audio videos in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for improved systems and processes for monitoring, detecting, and reporting vehicle emergencies to emergency services. There is a need for emergency detection and reporting systems that do not depend on municipal roadway cameras systems. There is a need for vehicular systems that effectively monitor and capture the audio and video of a vehicle's surroundings, detect vehicle emergencies, notify emergency services, aid in the determination of the cause of vehicle accidents, and assist in the arrest and conviction of people who drive irresponsibly or commit vehicle related insurance fraud.

The present invention, in one exemplary embodiment, is a novel vehicle safety system. The vehicle safety system includes a plurality of high definition and night vision cameras mounted on a vehicle's exterior as a means for capturing video images of the area around the vehicle, a plurality of multidirectional microphones mounted on a vehicle's exterior as a means for capturing audio sounds in the area around the vehicle, an electronic dashboard for receiving the captured video and the captured audio, and a pair of paddles for activating the cameras and microphones. The captured audio and captured video are stored in an internal memory for future use and review allowing authorities and companies to identify people, license plates and more.

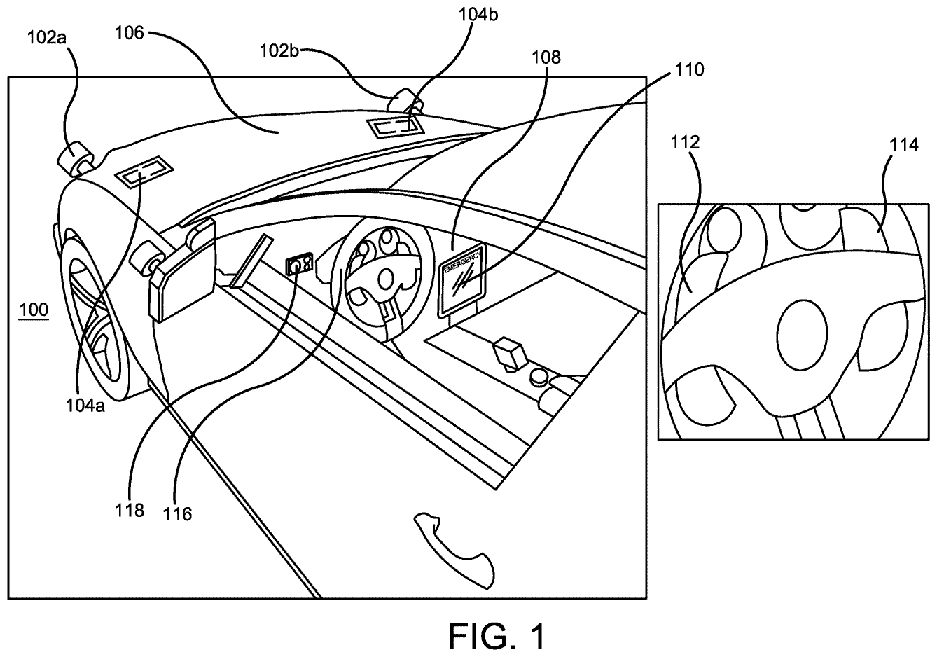

Referring initially to the drawings, FIG. 1 illustrates a perspective view of a vehicle equipped with one potential embodiment of the vehicle safety system 100 of the present invention in accordance with the disclosed architecture. The vehicle safety system 100 is designed to obtain and record video, audio, and audio video around a vehicle that may occur during incidents, accidents, and other situations on the roadway. The vehicle safety system 100 is integrated into a vehicle and assists in identifying reckless drivers and insurance fraud.

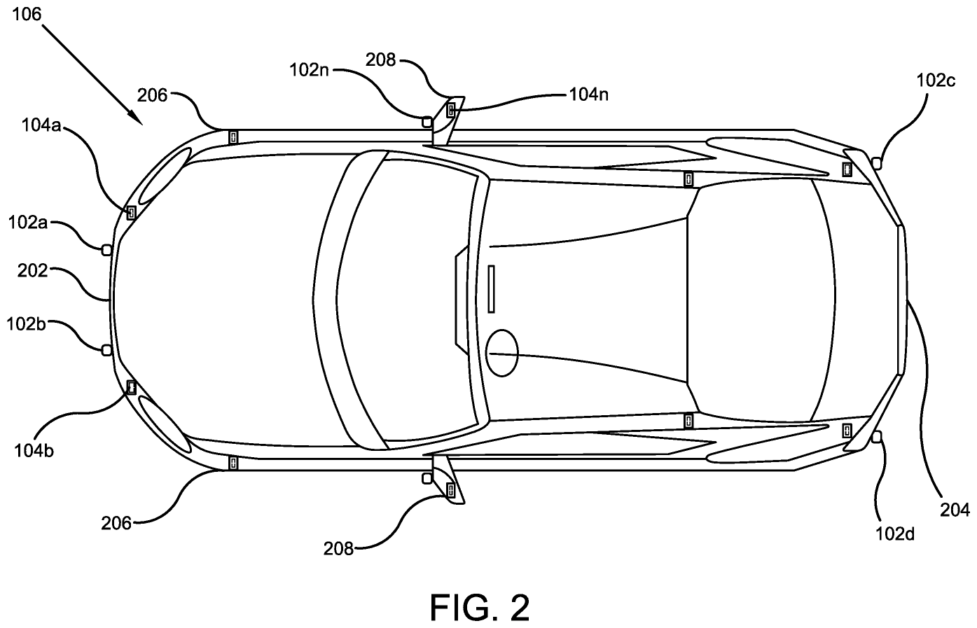

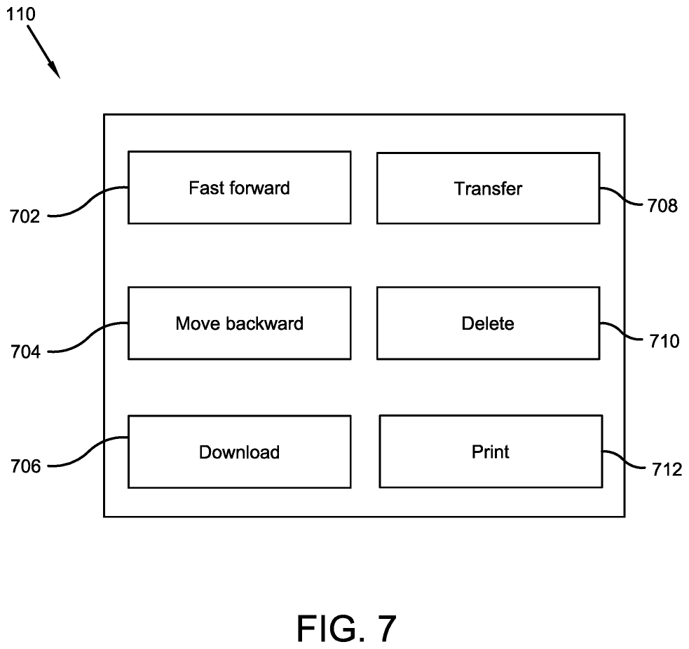

More specifically, the vehicle safety system 100 includes a plurality of high definition and night vision cameras 102a-n and a plurality of microphones 104a-n installed on the exterior of the vehicle 106. The vehicle 106 can be any personal or commercial vehicle wherein the cameras 102a-n and the microphones 104a-n are positioned at appropriate positions (such as, but not limited to, in front, on side mirrors, at the back and more) on the vehicle 106 as illustrated in FIG. 2. The cameras 102a-n and the microphones 104a-n are coupled to an electronic dashboard 108 of the vehicle 106. The electronic dashboard 108 has at least one associated display 110 that is used for displaying captured images, videos, and audio obtained with cameras 102a-n and microphones 104a-n. The display 110 is configured to display high-definition videos and images and provides a plurality of control options to customize and use the displayed content, as shown in FIG. 7. The display 110 may include any type of device capable of displaying information to one or more users of the vehicle 106. Examples of devices that can function as a display 110 include, but are not limited to: a monitor, LED display, LCD display, video projection device, touchscreens, and any other device that fulfills the same function as the display 100.

The cameras 102a-n capture still images and videos of the surroundings of the vehicle 106 as per preferences of a user. The microphones 104a-n record all types of sounds around the vehicle 106. The cameras 102a-n and the microphones 104a-n work in conjunction to provide complete surveillance of the surroundings of the vehicle. Each camera has a 360 degrees field of view and uses crisscross technology. Each camera may be a smart camera that includes at least one imaging sensor array and associated circuitry and image processing circuitry and electrical connectors and the like. The cameras 102a-n and the microphones 104a-n are preferably wireless devices that have a wireless connection for secure coupling to the electronic dashboard 108, allowing transmission of recorded images, videos, and audio in a wireless manner.

The vehicle safety system 100 provides at least one pair of hand operating paddles 112,114 for activating the cameras 102a-n and the microphones 104a-n. The left paddle 112 is positioned on left of the steering wheel 116 of the vehicle 106 and is configured to activate the cameras 102a-n to capture the still images and activating the microphones 104a-n for audio recording. The right paddle 114 is positioned on right of the steering wheel 116 of the vehicle 106 and is configured to be actuated for activating the cameras 102a-n to capture live video and activating the microphones 104a-n for audio recording. Although, the functions of each paddle 112,114 may be switched in a differing embodiment. Specifically, the paddles 112,114 are in the form of easily accessible buttons or levers located on either side of the steering wheel 116. A zoom button 118 is positioned on the dashboard 108 or steering wheel 116 to actuate the zoom feature of the cameras 102a-n allowing the vehicle safety system 100 to better record small and distant items such as license plates.

The vehicle safety system 100 can be installed in the vehicle 106 during the manufacturing of the vehicle 106 or after manufacture as an after-market purchase. If the vehicle safety system 100 is installed during the manufacturing of the vehicle 106 the electronic dashboard 108 can be integrated into the vehicle's infotainment system and additional cameras 102a-n and microphones 104a-n can also be installed as after-market components.

Also, when the paddles 112,114 are triggered the information screen may automatically divert to flash red, display the word “Emergency” and prompt the user to select “Yes” or “No” on the screen. If “Yes” is selected, a pre-installed GPS antenna would trigger the cell towers to determine the location of the vehicle via coordinates (if unknown by the vehicle operator) and activate 911 via the vehicle's OEM system (e.g., Onstar, Bluelink, etc.).

FIG. 2 illustrates a top view of the exemplary vehicle equipped with the vehicle safety system 100 of the present invention in accordance with the disclosed architecture. As illustrated, the vehicle 106 is equipped with a plurality of criss-cross cameras 102a-n and the microphones 104a-n positioned on the front 202, rear 204, side front 206, and side mirrors 208. The cameras 102a-n and the microphones 104a-n work together to provide audio and video data thereby allowing a user to capture surrounding of the vehicle 106. The presence of a plurality of microphones 104a-n is advantageous as impairments and external noise sources of the real world can be nullified. The microphones 104a-n use triangulation method to determine the angle and distance of the source of sound and indicate the same during display on the display screen. Similarly, the presence of plurality of cameras 102a-n capture the surrounding of the vehicle 106 from all directions and help in efficient use of crisscross technology.

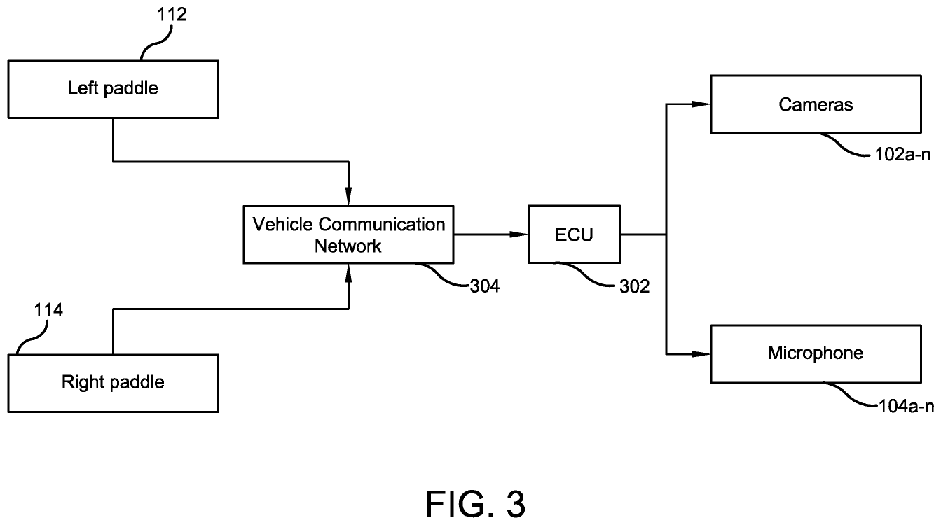

FIG. 3 illustrates a functional block diagram showing connection of the cameras 102a-n and the microphones 104a-n dispersed on the exterior of the vehicle 106 to the paddles 112 and 114 in accordance with the disclosed architecture. As illustrated, the left paddle 112 and the right paddle 114 are connected to an electronic control unit (ECU) 302 of the vehicle through a vehicle communication network 304 such as a controller area network (CAN). Other vehicle communication means may also be used, including LIN, Flexray, and any communication network that fulfills the same function.

The left paddle 112 is preferably configured to activate the cameras 102a-n and the microphones 104a-n where the cameras 102a-n capture still images and the microphones 104a-n capture surrounding audio. The right paddle 114 is preferably configured to activate the cameras 102a-n and the microphones 104a-n where the cameras 102a-n capture live videos and the microphones 104a-n capture surrounding audio. It should be noted that when the left paddle 112 is actuated, then, the right paddle 114 becomes inactive and vice versa.

The ECU 302 is configured to selectively activate the cameras and the microphones and is also configured to control the display 110 of the electronic dashboard 108 to display captured images, videos, and audio on the display 110 and through the audio output of the electronic dashboard 108.

Many variations of the vehicle safety system 100 are apparent to those skilled in the art. Variations may include a microphone built-in the electronic dashboard 108 or display 110 and the use of microphones 102a-n as speakers, or an additional speaker can be added, such that a user can communicate through the vehicle safety system 100 with those outside the vehicle. The cameras 102a-n and microphones 104a-n maybe equipped with lights which can be activated if the vehicle 106 is in an emergency situation. The system could be incorporated into autonomous or remotely controlled vehicles, allowing users to obtain live audio video of the vehicle from remote locations.

In another embodiment of the present invention, a vehicle emergency detection system 400 is disclosed. The vehicle emergency detection system includes all the elements of the vehicle safety system 100: a plurality of high definition and night vision cameras mounted on exterior of a vehicle for capturing video and images around the vehicle, a plurality of multidirectional microphones mounted on exterior of the vehicle for capturing sound and audio around the vehicle, an electronic dashboard for receiving the captured videos and audios, a pair of paddles for activating the cameras and microphones. In addition, the vehicle emergency detection system is configured to detect an emergency when one or more microphones capture a siren message, one or more cameras capture a rolled or damaged vehicle, or if the system receives a user confirmation of an emergency through the electronic dashboard. The system can be configured to automatically contact emergency services upon detecting a vehicle emergency. The system may be integrated into the vehicle during manufacturing of the vehicle or be installed as an aftermarket system.

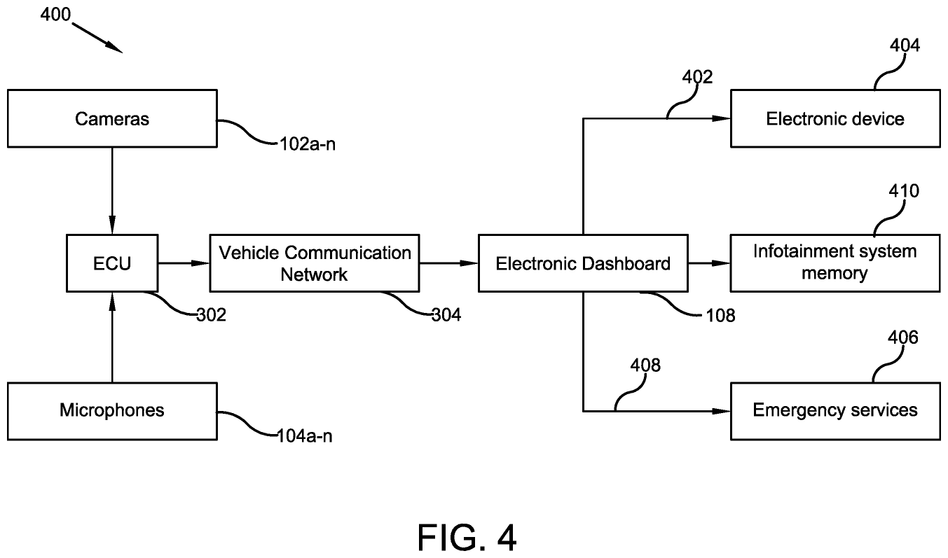

FIG. 4 illustrates a functional block diagram showing the components and the sequence of actions taken by the vehicle emergency detection system 400 for detecting vehicle emergencies. Upon receiving video and audio information from the cameras 102a-n and microphones 104a-n the ECU 302 analyzes the data for vehicle emergencies and transmits, using the vehicle's communication network 304 that may include CAN, wireless network, or any other communication means, information to the electronic dashboard 108.

The ECU 302 is configured to do an audio analysis of the audio signals received from the microphones 104a-n. The ECU 302 is capable of recognizing siren sounds (of an ambulance or of police) and when siren sounds are thereby detected the ECU 302 may send a signal to the electronic dashboard 108 to display EMERGENCY on the display device 110.

The ECU 302 is also configured to perform image analysis to determine if there is an emergency near the vehicle. The ECU 302 is capable of recognizing rolled over or damaged vehicles and when such images are recognized the ECU 302 sends a signal to the electronic dashboard 108 to display EMERGENCY on the display device 110.

The electronic dashboard 108 also connects with an electronic device 404 through a Bluetooth channel 402. The electronic device 404 may receive the contents of the cameras 102a-n and the microphones 104a-n via the Bluetooth channel 402 for display. Also, in case of an emergency, one or more emergency services 406 are contacted using cellular/Wi-Fi channel 408. Further, the electronic dashboard 108 also stores the captured content into the internal memory 410 of the electronic dashboard 108 from which the content can be downloaded and provided to authorities.

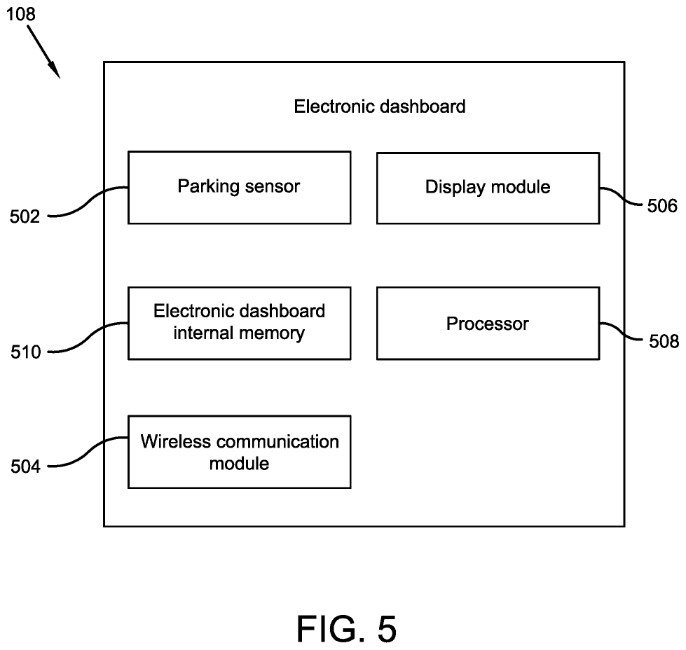

FIG. 5 illustrates a functional block diagram showing components of the electronic dashboard 108 of the present invention in accordance with the disclosed architecture. The electronic dashboard 108 includes at least one parking sensor 502 for detecting if the vehicle in which the system 100 is installed is in a parked condition. The parked condition is configured to automatically store recorded video and audio in the internal memory 410 of the electronic dashboard 108. The internal memory 410 can be expanded using removable memory devices.

At least one wireless communication module 504 is used for establishing one or more wireless channels allowing the electronic dashboard 108 to wirelessly couple with the cameras and microphones. A Bluetooth channel is established allowing the system to connect to an electronic device and a cellular signal may be established to contact a remote emergency service provider. The wireless communication module 504 can be in the form of an integrated chip and can be controlled by a processor 508. The processor 508 is a specialized processor for controlling operations of the electronic dashboard 108 and directly communicates with one or more ECUs 302 of the vehicle allowing the electronic dashboard 108 to collaborate with other functionalities of the vehicle.

At least one display module 506 provides a map display and a plurality of controls allowing a user to control and interact with the display 110. The display module 506 is coupled to the ECU 302 of the system 100 allowing easy display of the video, images, and audio.

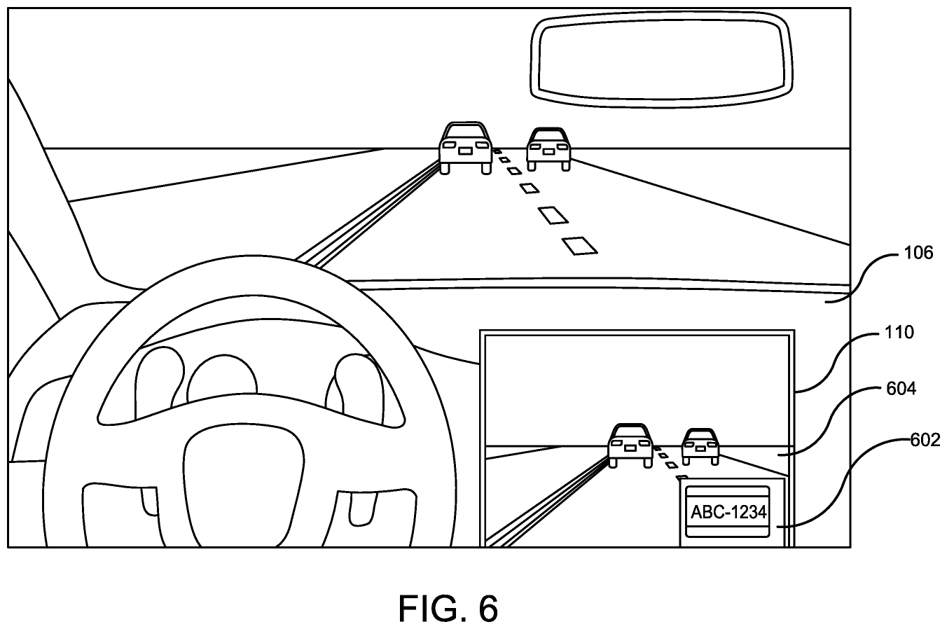

FIG. 6 illustrates a perspective view showing the vehicle emergency detection system 100 displaying a video of front of the vehicle and scanning a license plate of another vehicle in accordance with the disclosed architecture. As illustrated, the display device 110 displays the video 604 of the front of the vehicle 106 captured by the cameras positioned in front of the vehicle 106. Based on the preference of a user of the vehicle 106, the camera can be zoomed in using a zoom button 118 (not shown) and a license plate 602 of another vehicle can be scanned using a built-in scanner for display on the display device 110.

FIG. 7 illustrates a block diagram showing a plurality of controls displayed on the display 110 for controlling the images, video, and audio played on the display 110 in accordance with the disclosed architecture. The display 110 provides a fast forward control 702 for moving the video forward when playing recorded video. A move backward control 704 moves the video back by a predetermined time. The predetermined time may be approximately ten seconds, twenty seconds, or other amount of time.

A download control 706 allows the users to download the images, video, and audio in an appropriate format to any device connected to the electronic dashboard 108. A transfer control 708 allows one or more of the stored images, video, and audio files in the electronic dashboard 108 to be transferred to any external device either through a wireless medium or a wired medium. A delete control 710 enables users to selectively delete one or more images, video, and audio files from the internal memory of the system. A print control 712 allows a user to give a print command allowing an image to be printed to a connected printer. Additional controls such as upload, contact emergency and others may also be provided to users for controlling the system 100,400 and providing safety to the users by capturing surroundings.

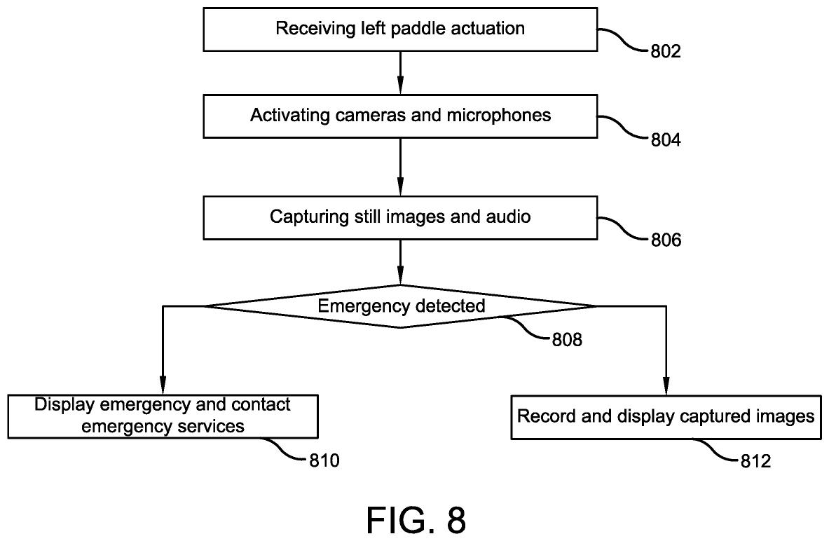

In yet another embodiment, a process for detecting vehicle emergencies is disclosed in accordance with the disclosed architecture of the invention. FIG. 8 illustrates a flow diagram depicting the exemplary process performed by the vehicle emergency detection system 400 to capture images and audio from which it detects vehicle emergencies in accordance with the disclosed architecture. As illustrated, initially, an actuation signal is received by a user pressing on the left paddle 112 of the system (Step 802) upon which the ECU activates cameras and microphones to capture the images and audio of the surroundings. (Steps 804,806). The ECU is configured to analyze the images and audio to detect emergency events. Alternatively, a user may inform the system of a user-observed emergency event.

Upon detecting an emergency event (Step 808) or a user informing the vehicle emergency detection system 400 of an emergency event, the images and audio are recorded on the system's internal memory, a user is informed an emergency has been detected as EMERGENCY is displayed on the display of the electronic dashboard and the display may turn red. Furthermore, the zoom function and scanner are automatically activated. One or more emergency services may be contacted by the vehicle emergency detection system 400 (Step 810).

Under situations in which an emergency is not detected, the system continues to capture images and audio and the images and audio can be recorded on the internal memory of the system or into the memory of a coupled electronic device (Step 812). In non-emergency, the cameras can capture photos and/or videos when triggered by a driver to record other vehicles, monuments, important roadway structures, historic areas, or other events and views of interest.

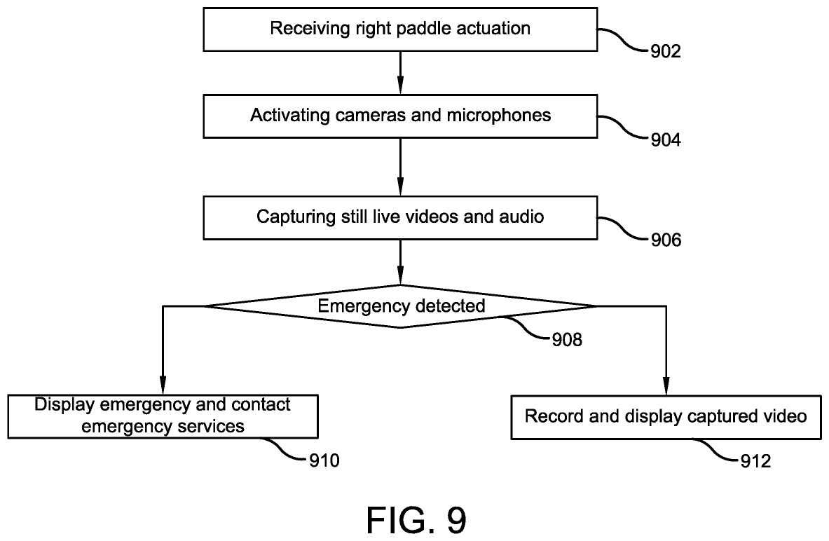

FIG. 9 illustrates a flow diagram depicting the exemplary process performed by the vehicle emergency detection system 400 to record live audio video recordings upon detection of an emergency event in accordance with the disclosed architecture. As illustrated, initially, an actuation signal is received by a user pressing on the right paddle 114 of the system (Step 902). Accordingly, the ECU 302 activates the cameras 102a-n and microphones 104a-n to capture live audio video of the surroundings (Steps 904,906). Thereafter, when an emergency event is detected by the vehicle emergency detection system 400 (Step 908) the vehicle emergency detection system 400 will notify the user by displaying EMERGENCY on the display 110, will contact emergency services, (Step 910) and will record the audio video on the system's internal memory (Step 912). Furthermore, the zoom function for the cameras and scanner are automatically activated.

In variations of this process, the emergency can be detected automatically by the ECU based on the analysis of the video analysis and audio or a user may actuate the system based on a user observed emergency event. The process can also be initiated remotely using a paired electronic device to actuate the right paddle or send a signal to the ECU 302 directly through the wireless network 304 to which the electronic device is paired.

Under situations in which an emergency is not detected, the system continues to capture images and audio and the images and audio can be recorded on the internal memory of the system or into the memory of a coupled electronic device (Step 912). In non-emergency, the cameras can capture photos and/or videos when triggered by a user to record other vehicles, monuments, important roadway structures, historic areas, or other events and views of interest. The system may be part of an OEM, or may also be utilized as an aftermarket system. Also, the system is not limited to any particular type of vehicle and can be utilized with any human controlled automobile, bicycle, boat, etc. that has a steering component.

The system may also help families, authorities, emergency personnel etc. determine what occurred during a particular event by enabling them to capture multiple types of events in real time that can then be edited and transferred to the appropriate personnel at the time of the incident via USB, NFC, Bluetooth, etc.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle safety system”, “vehicle emergency detection system”, and “system”, are interchangeable and refer to the audio and video system for capturing surroundings of a vehicle for detecting emergency of the present invention.

Notwithstanding the foregoing, the vehicle safety system 100 and the vehicle emergency detection system 400 of the present invention can be of any suitable size and configuration as is known in the art without affecting the overall concept of the invention, provided that it accomplishes the above-stated objectives. One of ordinary skill in the art will appreciate that the vehicle safety system 100 and the vehicle emergency detection system 400 as shown in the FIGS. are for illustrative purposes only, and that many other sizes and shapes of the systems 100 400 are well within the scope of the present disclosure. Although the dimensions of the systems 100 400 are important design parameters for user convenience, the systems 100 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle safety system comprising:
a video camera;
a microphone, wherein the video camera and the microphone are attached to a vehicle;
an electronic control unit in communication with the camera and the microphone;
a vehicle communication network;
a pair of paddles comprised of a left paddle and a right paddle attached to a steering wheel of the vehicle, wherein the pair of paddles are in communication with the electronic control unit through the vehicle communication network and the left paddle is configured to activate the video camera to capture a still image and the right paddle is configured to activate the video camera and the microphone to obtain an audio video recording; and
an electronic dashboard in communication with the electronic control unit through the vehicle communication network and configured to receive a user input and to receive the still image and the audio video recording obtained by the video camera and having a visual display to output the still image and the audio video recording.

2. The vehicle safety system of claim 1, wherein the electronic dashboard further comprises a zoom feature that allows the video camera to zoom.

3. The vehicle safety system of claim 2 further comprising a scanner configured to scan a vehicle license plate.

4. The vehicle safety system of claim 1 further comprising an internal memory for storing the still image and the audio video recording.

5. The vehicle safety system of claim 1, wherein an installation of the vehicle safety system is integrated into a vehicle manufacturing process.

6. The vehicle safety system of claim 1, wherein the vehicle safety system is added to the vehicle after manufacture of the vehicle.

7. A vehicle emergency detection system comprising:
a plurality of video cameras;
a plurality of microphones, wherein the plurality of video cameras and the plurality of microphones are attached to a vehicle;
an electronic control unit in communication with the plurality of video cameras and the plurality of microphones;
a vehicle communication network;
a pair of paddles comprised of a left paddle and a right paddle attached to a steering wheel of the vehicle, wherein the pair of paddles are in communication with the electronic control unit through the vehicle communication network and the left paddle is configured to activate the plurality of video cameras to capture a still image and the right paddle is configured to activate the plurality of video cameras and the plurality of microphones to obtain an audio video recording;
an electronic dashboard in communication with the electronic control unit through the vehicle communication network and configured to receive an user input and to receive the still image and the audio video recording obtained by the plurality of video cameras and having a visual display to output the still image and the audio video recording; and
wherein the electronic control unit is configured to detect at least one of:
a siren sound obtained by at least one of the plurality of microphones;
an image of a distressed vehicle obtained by at least one of the plurality of video cameras; and
a vehicle emergency.

8. The vehicle emergency detection system of claim 7, wherein the plurality of video cameras further comprise a zoom feature.

9. The vehicle emergency detection system of claim 8 further comprising a scanner configured to scan a vehicle license plate.

10. The vehicle emergency detection system of claim 7, wherein the electronic dashboard is configured to receive a user input of an emergency situation.

11. The vehicle emergency detection system of claim 10, wherein the electronic dashboard is configured to contact an emergency service when the emergency situation exists.

12. The vehicle emergency detection system of claim 7 further comprising an internal memory.

13. The vehicle emergency detection system of claim 12, wherein the vehicle emergency detection system is configured to transfer the still image and the audio video recording to a coupled electronic device.

14. The vehicle emergency detection system of claim 7 further comprising a park sensor wherein the electronic dashboard is further configured to receive a signal from the park sensor to detect when the vehicle is parked, and further wherein the electronic dashboard is configured to activate the plurality of video cameras and the plurality of microphones upon detecting that the vehicle is parked.

15. The vehicle emergency detection system of claim 7, wherein the vehicle emergency detection system is integrated into the vehicle during a manufacturing process.

16. The vehicle emergency detection system of claim 7, wherein the vehicle emergency detection system is added to the vehicle after manufacture of the vehicle.

17. A method for detecting an vehicle emergency comprising the steps of:
activating a plurality of cameras and a plurality of microphones on a vehicle via a pair of paddles attached to a steering wheel of the vehicle;
capturing a plurality of images and an audio via at least one of the plurality of cameras and the plurality of microphones;
capturing an audio-video via at least one of the plurality of cameras and the plurality of microphones;
detecting the vehicle emergency through an analysis of the captured plurality of images and the audio;
displaying an emergency notification to a user; and
contacting an emergency service.

18. The method for detecting a vehicle emergency of claim 17 further comprising a step of zooming at least one of the plurality of cameras as a means to obtain the plurality of images and the audio-video.

19. The method for detecting a vehicle emergency of claim 17 further comprising a step of scanning a license plate of a surrounding vehicle.

20. The method for detecting a vehicle emergency of claim 17 further comprising a step of pairing the vehicle with a device as a means of detecting vehicle emergencies remotely.
